(19) United States
(12) Patent Application Publication
(10) Pub. No.: US 2024/0376950 A1
(43) Pub. Date: Nov. 14, 2024

(54) GAS SPRING WITH HYDRAULIC ACCUMULATOR

(71) Applicant: Dadco Inc., Plymouth, MI (US)

(72) Inventor: Jason L. Vandine, Redford, MI (US)

(21) Appl. No.: 18/688,003

(22) PCT Filed: Oct. 7, 2022
(86) PCT No.: PCT/US2022/045968

§ 371 Date: Feb. 29, 2024

Related U.S. Application Data
(60) Provisional application No. 63/254,295, filed on Oct. 11, 2021.

(51) Int. Cl. F16F 9/06; F15B 1/24; F16F 9/32; F16F 9/34; F16F 9/516

(52) U.S. Cl. CPC F16F 9/065; F15B 1/24; F16F 9/3264; F16F 9/3292; F16F 9/3405; F16F 9/516; F16F 2222/126; F16F 2228/066; F16F 2230/0023; F16F 2230/0047; F16F 2230/08; F16F 2230/30

(57) ABSTRACT

An industrial gas spring with a hydraulic accumulator includes a piston rod of the received in a hydraulic chamber connected to a gas over hydraulic fluid accumulator chamber in which a compressed gas determines the force required to yieldably move the piston rod from its extended position to its retracted position. On a return stroke of the piston rod as it approaches its fully extended position, a hydraulic damper chamber in the hydraulic cylinder may reduce the velocity of the returning piston rod. The damper chamber may return a hydraulic fluid through an orifice to the hydraulic cylinder chamber. The orifice may provide a varying restriction to vary and control the velocity or rate at which the piston rod returns to its fully extended position.

### CROSS-REFERENCE TO RELATED APPLICATIONS

This application claims the benefit of U.S. Provisional Application No. 63/254,295 filed Oct. 11, 2011, which is incorporated by reference in its entirety.

### TECHNICAL FIELD

This invention relates generally to industrial gas springs for forming equipment and more particularly to industrial gas springs with piston rod stroke dampers.

### BACKGROUND

Industrial gas springs are well known and have been used in many applications of forming equipment including stamping dies, progressive dies, and racks for progressive dies, for sheet metal stamping, punching, and piercing operations.

A conventional industrial gas spring may include a casing, a piston rod received in part in the casing, a piston rod bearing and seal assembly and a pressure chamber to hold pressurized gas, typically nitrogen, at an operating pressure of, for example, 1,000 to 5,000 psi in some applications. The pressurized gas biases the piston rod to its extended position and yieldingly resists movement of the piston rod from its extended position to its retracted position. In some applications the pressurized gas returns the piston rod from its retracted position to its fully extended position with such a high velocity and force that it produces undesirable vibration and workpiece movement and may even result in dislocation of a workpiece and cause damage to the die or other equipment in which it is used. In some applications this undesirable vibration and workpiece movement has been reduced by use of a separate shock absorber assembly spaced laterally away from the gas spring. But the separate shock absorber assembly adds cost and complexity to the application and introduces a moment arm that is attributed to a distance between the gas spring and the shock absorber assembly and that can lead to stress in such applications. In other applications this undesirable vibration and workpiece movement has been reduced by a cushion chamber in which gas is compressed as the piston rod returns to its fully extended position but this compressed gas cushion chamber may cause the piston rod to momentarily partially retract into the cylinder before it reaches its fully extended position and thus still produce some undesirable vibration and workpiece movement. Such a gas spring is disclosed in U.S. Pat. No. 9,416,840 assigned to Dadco Inc. Therefore, there is still a need for a gas spring which further dampens and significantly reduces this undesirable vibration and workpiece movement.

### SUMMARY

In some applications an industrial gas spring may include a self-contained or preferably linked, hydraulic cylinder assembly with a dampener on the return stroke. In some applications a piston rod may be received in a hydraulic chamber connected to a gas over hydraulic fluid accumulator chamber in which a compressed gas such as nitrogen determines the force required to yieldably move the piston rod from its extended position to its retracted position. On a return stroke of the piston rod as it approaches its fully extended position a hydraulic damper chamber in the hydraulic cylinder may reduce the velocity of the returning piston rod. In some applications the damper chamber may return a hydraulic fluid such as an incompressible hydraulic oil through a throttling or restricted orifice to the hydraulic cylinder chamber. In some applications the orifice may provide a varying restriction to vary and control the velocity or rate at which the piston rod returns to its fully extended position. The hydraulic damper chamber when activated counteracts the force on the piston rod created by the nitrogen gas in the accumulator chamber and causes the returning piston rod to slow down at a predetermined rate.

### BRIEF DESCRIPTION OF THE DRAWINGS

The following detailed description of preferred embodiments and best mode will be set forth with regard to the accompanying drawings in which:

FIG. 1 is a side view of an industrial gas spring assembly in accordance with an illustrative embodiment of the present disclosure;

FIG. 2 is a top view of the gas spring assembly of FIG. 1;

FIG. 3 is a full sectional view of the gas spring assembly with the piston rod in its fully extended position taken on line 3-3 of FIG. 2;

FIG. 4 is a full sectional view of the gas spring assembly with the piston rod shown in a designed fully retracted position:

FIG. 5 is a full sectional view of the gas spring assembly with the piston rod shown in a partially extended position:

FIG. 6 is an isometric view of a modified industrial gas spring assembly with tie rods:

FIG. 7 is an enlarged fragmentary sectional view of a portion of the gas spring assembly of FIG. 1:

FIG. 8 is a further enlarged fragmentary view of a more specific portion of the gas spring assembly of FIG. 1, taken from circle 8 of FIG. 7:

FIG. 9 is an isometric view of a collar of a damper of the gas spring assembly of FIG. 1:

FIG. 10 is a full sectional view of the collar taken on line 10-10 of FIG. 9:

FIG. 11 is a full sectional view of a modified accumulator:

FIG. 12 is a full sectional view of another modified accumulator:

FIG. 13 is an isometric view of an industrial gas spring assembly in accordance with another illustrative embodiment of the present disclosure:

FIG. 14 is a central longitudinal cross-sectional view of the assembly of FIG. 13:

FIG. 15 is an isometric view of a check valve of the assembly of FIG. 13:

FIG. 16 is a top view of the check valve of FIG. 15; and

FIG. 17 is a cross-sectional view of the check valve of FIG. 15, taken along line 17-17 of FIG. 16.

### DETAILED DESCRIPTION OF PREFERRED EMBODIMENTS

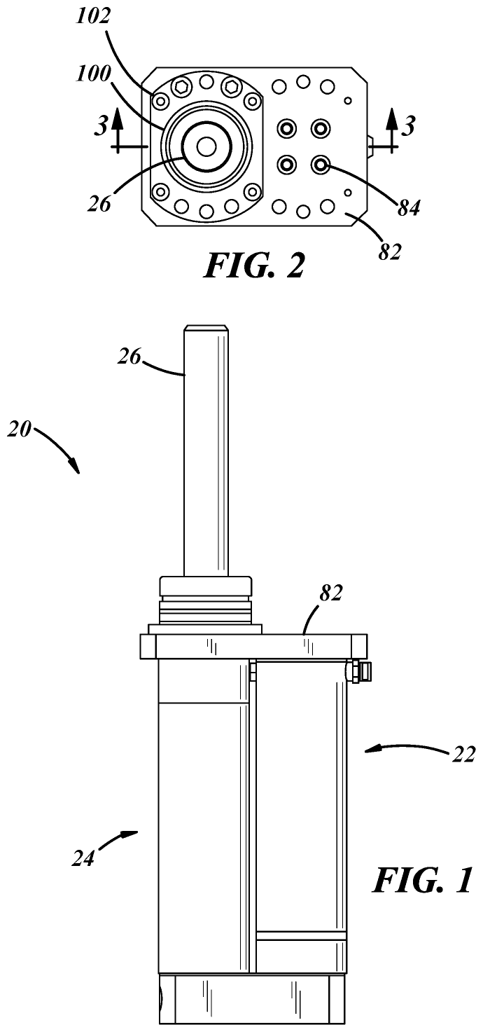

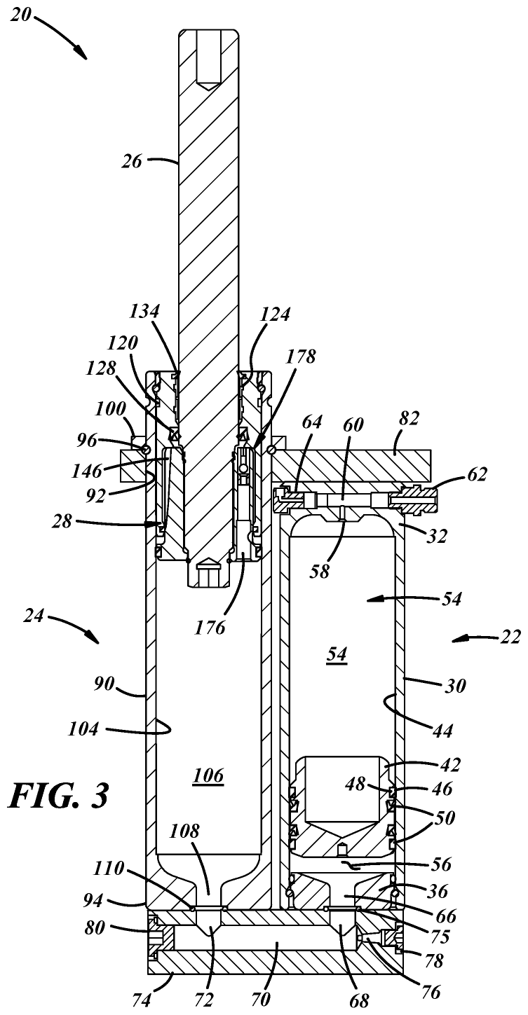

Referring in more detail to the drawings, FIGS. 1-3 illustrate an industrial gas spring assembly 20 including an accumulator cylinder 22 and a hydraulic cylinder 24 with a piston rod 26 and a hydraulic damper 28 (FIG. 3). In use the accumulator cylinder 22 provides a pressurized hydraulic fluid (sometimes herein after referred to as hydraulic oil) to the hydraulic cylinder 24 to yieldably urge the piston rod 26 to its fully extended position and the hydraulic damper 28 decreases the velocity of the piston rod 26 as it approaches its fully extended position.

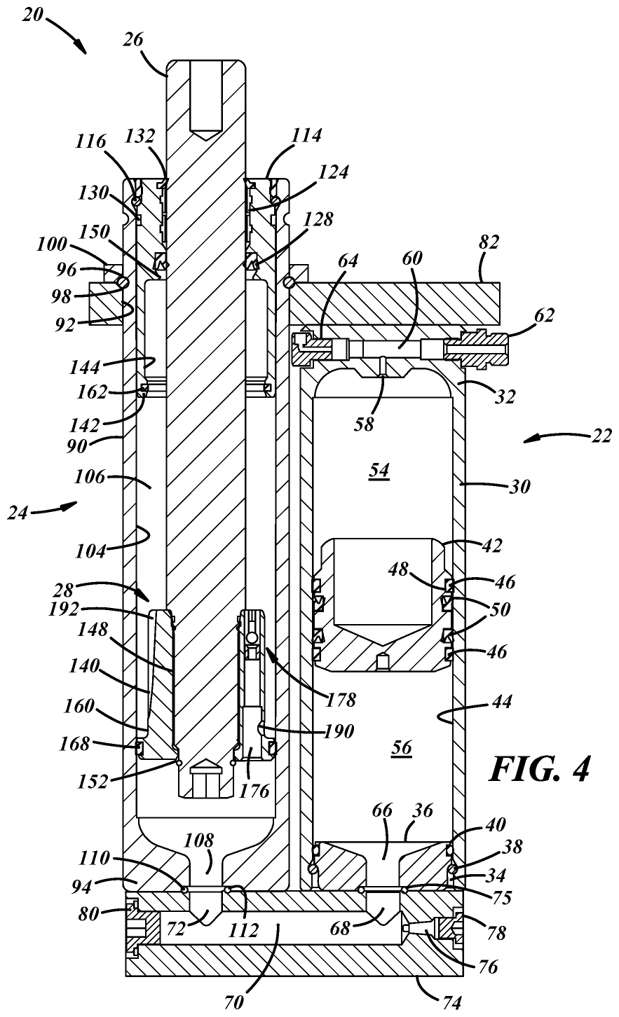

As best shown in FIGS. 4 & 5, the accumulator cylinder 22 may have a tubular casing 30 with a closed end 32 and an open end 34 with a head 36 received and removably retained therein by a retaining ring 38 and with a seal 40 such as an o-ring received between them. A piston 42 may be slidably received in an inner cylindrical surface or bore 44 of the casing 30 with seals 50 such as O-rings between them and received in grooves 48 of the piston 42. If desired, guide rings or bearings 46 may also be received in grooves in the piston 42 and bear on the casing 30. The piston 42 and casing 30 may define a gas chamber 54 on one side of the piston 42 and on its other side a hydraulic fluid accumulation chamber 56.

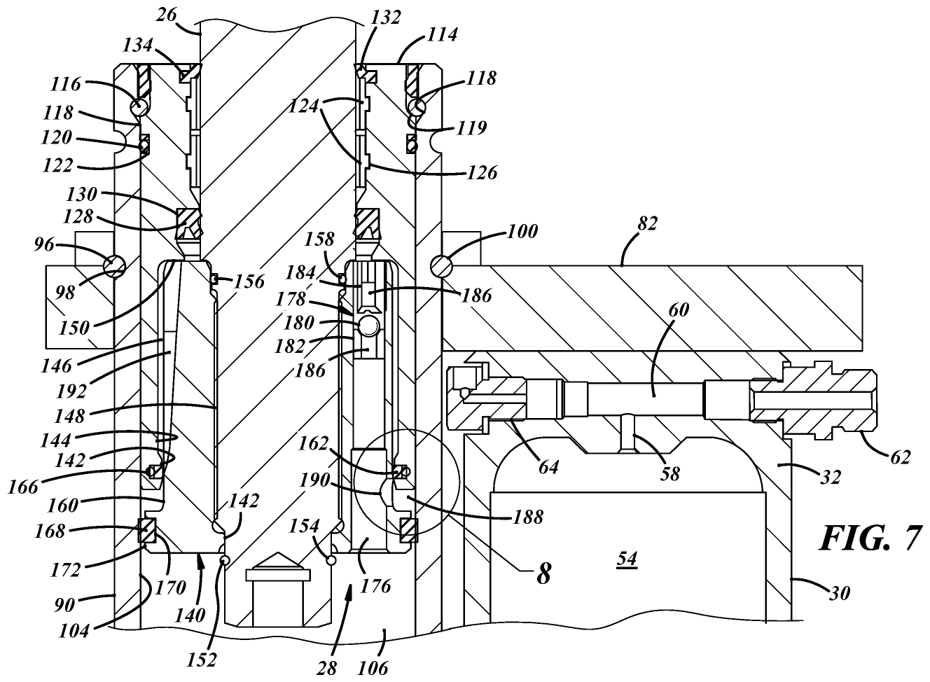

As best shown in FIG. 7, for charging the gas chamber 54 with a compressed gas such as nitrogen (and/or discharging the compressed gas) a port 58 may communicate it with a passage 60 communicating with a fill adapter 62 which may include a valve (not shown) such as a Schrader valve for opening and closing communication with the passage 60. An overpressure relief valve assembly 64, a rupture disc, or the like may also be received in the passage 60) to communicate the gas chamber 54 with the atmosphere exteriorly of the casing 30 in the event of and to relieve an overpressure condition occurring in the gas chamber 54.

As shown in FIGS. 3-5, the hydraulic fluid accumulation chamber 56 may continuously communicate with the hydraulic cylinder 24 via a passage 66 through the head 36 communicating with interconnected passages 68, 70 & 72 in a base plate 74. An O-ring seal 75 (FIG. 4) may encircle the passages 66 & 68 and be received between the head 36 and the base plate 74. A hydraulic oil fill valve 76 and a protective plug 78 may communicate with one end of the passage 70 which may be closed and sealed at its other end by a plug 80 threaded therein. The accumulator cylinder 22 may be received between and attached to the base plate 74 by cap screws (not shown) threaded into the head 36 and a top plate 82 by cap screws 84 (FIG. 2).

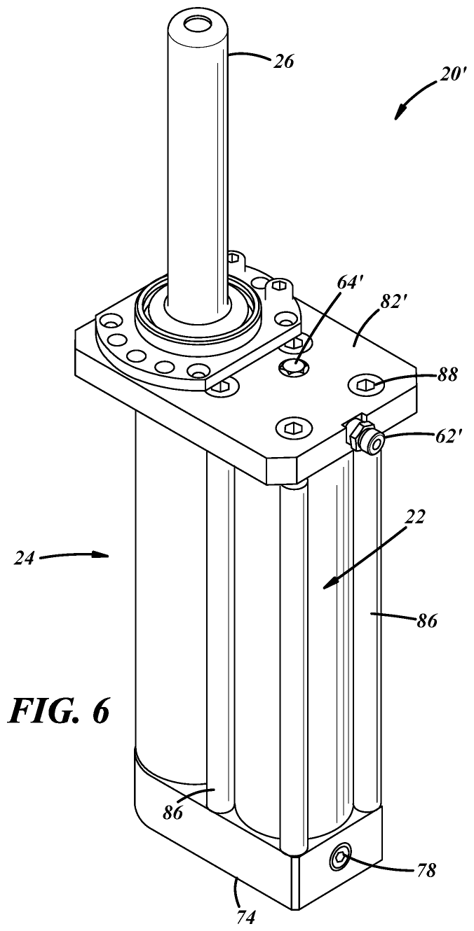

Alternatively, as shown in FIG. 6, according to another embodiment of a gas spring assembly 20′, the accumulator cylinder 22 and top and bottom plates 82′ & 74′ may be retained in assembled relationship by tie rods 86 attached to the plates by cap screws 88 or the like. Also, a pressure relief valve 64′ and a fill adapter 62′ may be carried by the top plate 82′ along with corresponding passages (not shown).

As shown in FIGS. 3, 4 & 5, the hydraulic cylinder 24 may have a tubular casing 90 slidably received through a bore 92 in the top plate 82 with its closed end 94 bearing on the base plate 74 and releasably retained in assembly by a ring 96 received in part in a groove 98 in the casing 90 and complementary recesses in the outboard face of the top plate 82 and an abutting face of a retainer plate 100 slidablely received over the casing 90 and secured to the top plate by cap screws 102. The casing 90 may have an inner cylindrical surface or bore 104 which defines in part a first or main hydraulic chamber 106 which communicates through a passage 108 through its closed end with the passages 68, 70 & 72 in the base plate 74 and 30) thus the accumulator hydraulic fluid accumulation chamber 56. A seal 110 may be provided by an o-ring encircling the passages 108 & 72 and received between the casing closed end 94 and the base plate 74, for example, in a groove 112 in the closed end 94 of the casing 90.

As best shown in FIG. 7 the piston rod 26 may be slidablely received through an annular housing 114 with one end extending into the first hydraulic chamber 106 and its other end axially outboard of the casing 90 at least when the piston rod 26 is in its fully extended position. The annular housing 114 may be removably received in the casing 90 and retained therein by a retaining ring 116 received in a complimentary groove 118 in the casing 90 and against a shoulder 119 of the housing 114 adjacent its outboard end. A seal 120 may be provided between the casing bore 92 and the housing 114 such as by an o-ring received between them and in a groove 122 in the housing 114. The piston rod 26 may be slidably received through guides or bearings 124 received in grooves 126 in the housing 114 and a piston rod seal 128 may be received in a groove 130 in the housing 114. A piston rod wiper 132 may also be received in a groove 134 adjacent the outboard end of the housing 114.

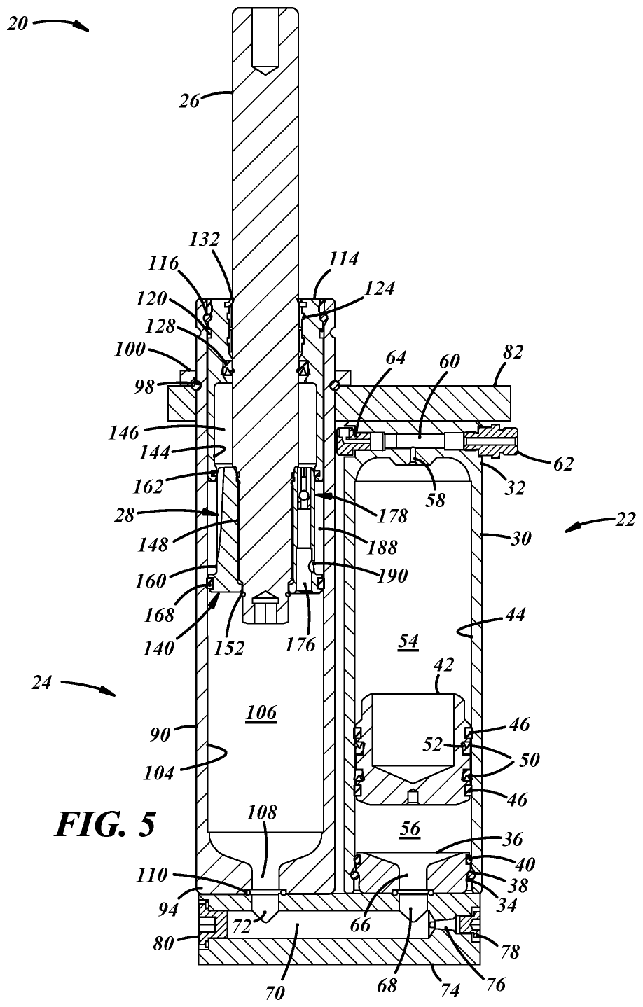

As best shown in FIGS. 4, 5 & 7, the hydraulic damper 28 may have an annular collar 140 carried by the piston rod 26 for movement in unison therewith and which, as shown in FIGS. 4 & 5, during movement of the piston rod 26 from its retracted position (shown in FIG. 4) toward its fully extended position (FIG. 3) enters through a bore 142 and into a counterbore or pocket 144 in the annular housing 114 to provide a second or secondary hydraulic chamber 146 which decreases the velocity or rate at which the piston rod 26 moves to its fully extended position. The collar 140 may be received and retained on a reduced diameter cylindrical portion 148 of the piston rod 26 with one end of the collar 140 bearing on a shoulder 150 and a retainer ring 152 received in a groove 154 in the rod 26 and bearing on the other end of the collar 140. A seal 156 may be provided between the collar 140 and the piston rod 26 such as by an o-ring received in a groove 158 in the rod.

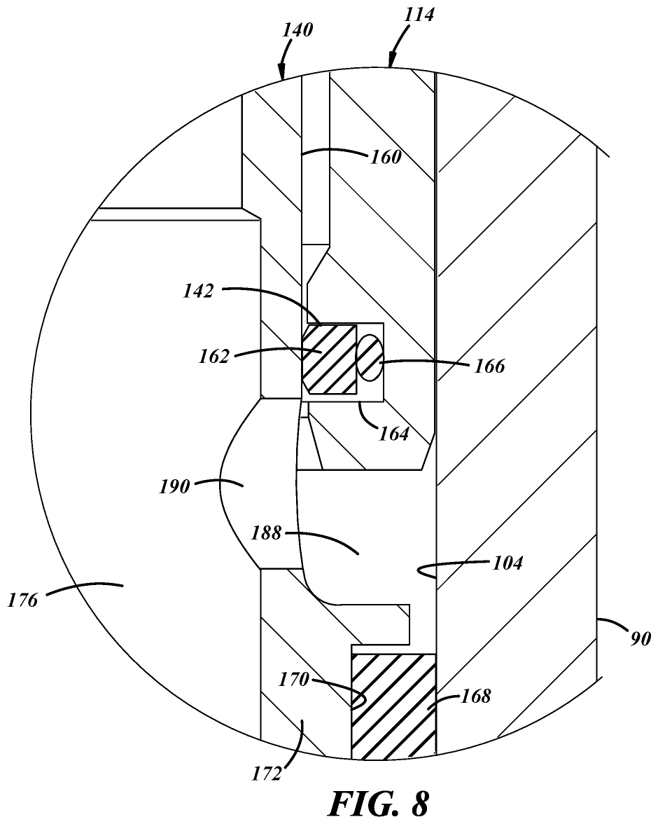

With reference to FIG. 8, a seal 162 may be provided between an outer cylindrical surface 160 of the collar 140 when received in the housing bore 142 such as by a hard and wear resistant plastic seal received in a groove 164 in the housing 114 along with a high temperature o-ring 166 vieldablely biasing this plastic seal into engagement with this collar 140. This plastic seal may be made of a polyacetal, polyamide or polyolefin material which may have a durometer in the range of 70 to 100 on the Rockwell scale, including all ranges, sub-ranges, values, and endpoints of the aforementioned range. A split ring guide or bearing 168 may be received in an outwardly opening groove 170 in an exterior flange 172 of the collar 140 and slidably bear on the cylindrical bore 104 of the casing 90.

30) With continued reference to FIG. 8, to facilitate the rapid flow of hydraulic oil while the piston rod 26 (FIG. 7) is being retracted from its fully extended position and subsequently advanced toward its extended position at least until the collar 140 engages the seal 162, the collar 140 has at least one and desirably a plurality of circumferentially spaced apart passages 176 extending generally axially through the collar 140, within its annular wall and opening to or communicating with both ends of the collar 140. To at least substantially restrict and desirably prevent the flow of hydraulic oil from the secondary hydraulic chamber 146 through these passages 176 as the collar 140 further advances into the secondary hydraulic chamber 146 (as the piston rod 26 advances further toward its fully extended position), a check valve assembly 178 received in each passage 176 closes. As best shown in FIG. 7, each check valve assembly 178 may have a ball 180 engageable with a seat 182 when closed and engageable with a retainer 184 when open. Both the seat 182 and the retainer 184 have through bores 186 through which hydraulic oil may flow, and/or oil may flow around the retainer 184. Upon a retraction of the piston rod 26 and thus the collar 140, each check valve assembly 178 opens to permit substantially unrestricted flow of hydraulic oil through these passages 176 and/or around the retainer 184. Desirably, to avoid any significant pressure differential between the first hydraulic chamber 106 and an annular space 188 between the housing 114 and the flange 172 of the collar 140 they may continuously communicate such as through a port 190 and open ends of the passages 176.

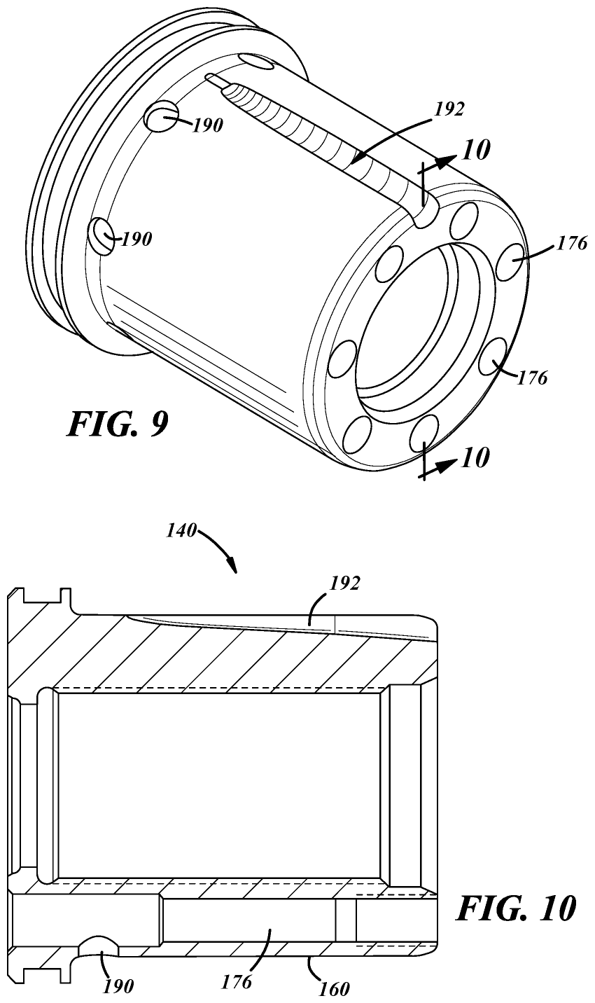

When the piston rod 26 advances toward its fully extended position sufficiently for the cylindrical surface 160 of the hydraulic damper 28 to engage the seal 162, the check valves 178 close due to the increasing pressure of the hydraulic oil in the secondary hydraulic chamber 146 (as the piston rod 26 and collar 140 further advance) which then flows at least essentially only through a restricted orifice 192 in an outer cylindrical surface of the collar 140 to thereby decrease the velocity or rate at which the piston rod 26 further moves to its 20) fully extended position. Desirably, as shown in FIGS. 9 & 10, the orifice 192 extends generally axially from the proximate end toward the distal end of the collar 140 with a varying cross section which decreases in cross sectional area as the orifice 192 extends toward the distal or flange 172 end of the collar 140. Desirably, the orifice 192 may be configured so that it ends at or slightly after the seal 162 when the proximal end of the collar 140 engages the housing shoulder 150 and thus, the piston rod 26 is in its fully extended position. This variable orifice 192 decreases the rate of flow of hydraulic oil from the secondary hydraulic chamber 146 into the first or main hydraulic chamber 106 as the collar 140 advances into the secondary hydraulic chamber 146 to thereby decrease the rate at which the piston rod 26 advances to its fully extended position.

The size, shape, and varying cross sectional area of the variable orifice 192 may be determined in any suitable manner such as empirically or by dynamic incompressible fluid flow formulas and calculations as will be apparent to one of ordinary skill in the art. The configuration of the variable orifice 192 may be formed in the collar 140 such as by a ball nose end mill used to machine the orifice 192 therein. The variable orifice 192 may be at least partially semicircular in cross sectional shape and may be parabolic through at least part of its longitudinal extent.

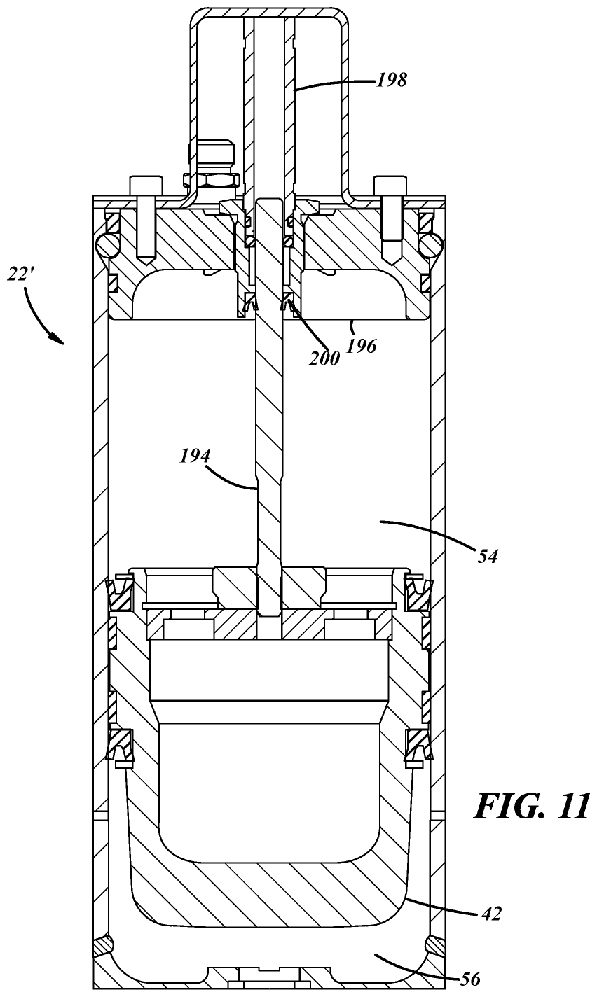

For use of the gas spring 20, the first hydraulic chamber 106 including the annular space 188, secondary hydraulic chamber 146, hydraulic fluid accumulation chamber 56 and interconnecting passages 66, 68, 70, 72 & 108 are filled with sufficient hydraulic oil so that when the piston rod 26 is fully extended, the accumulator piston 42 is spaced from the head 36 such as shown in FIGS. 3-5. To facilitate knowing when the accumulator piston 42 is spaced from the head 36, as shown in FIG. 11, an indicator rod 194 may be fixed to the accumulator piston 42 for movement with it and slidably extend through the upper end of the accumulator cylinder 22 and into a transparent sight glass 198 mounted on the upper end of the accumulator cylinder 22. Suitable seals 200 such as o-rings may be disposed between the indicator rod 194 and the upper end of the accumulator cylinder 22.

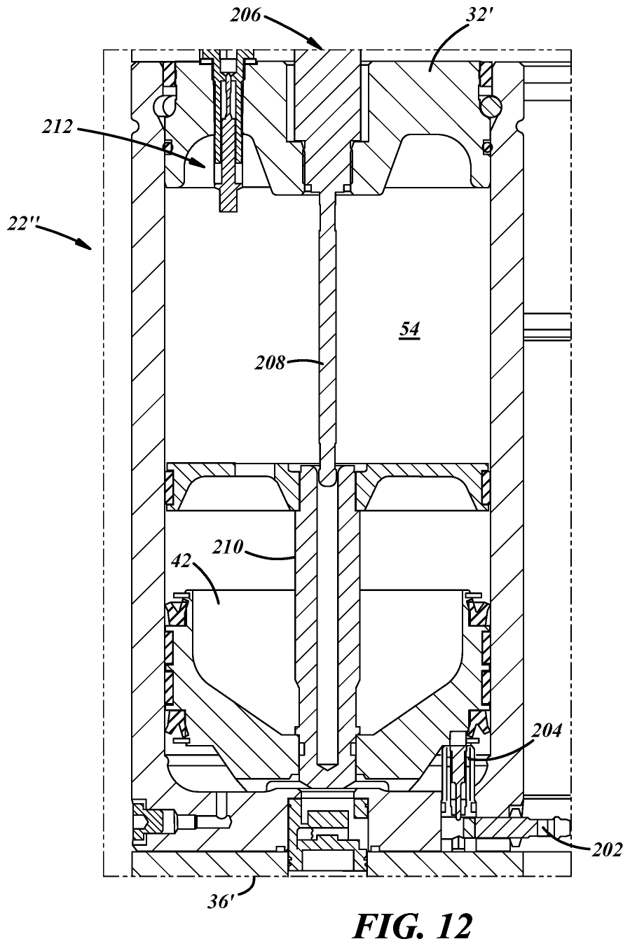

Alternatively, as shown in FIG. 12, a sensor 202 such as a proximity sensor and associated electrical or electronic circuitry may be used to determine and indicate whether the accumulator piston 42 is spaced from the end or head 36 of the hydraulic fluid accumulation chamber 56. The proximity sensor 202 may be mounted in this lower end 36; or head and responsive to the position of a rod 204 fixed to and depending from the accumulator piston for movement therewith. A suitable proximity sensor is available from Automation Direct.com as model No. AEI-AP-3F. If desired, the position of this piston relative to the upper end 32 or head 32; of the accumulator gas chamber 54 may be determined and indicated by a suitable linear position sensor carried 206 by the upper end of the accumulator cylinder 22 with a probe 208 which extends axially and slidably into a tube 210 fixed to this piston for movement therewith. A suitable linear position sensor is available from Alliancesensors.com as model No. MHPE-7-100-08-01-11-S-08CS.

The accumulator gas chamber 54 is filled with a compressed inert gas such as nitrogen to the superatmospheric pressure needed to produce the desired magnitude of the force resisting initial movement of the piston rod 26 from its fully extended position toward a retracted position. Compressed gas may be supplied to the gas chamber 54 through the adaptor and filler valve 62 to the desired pressure which may be indicated by a suitable pressure gauge. As shown in FIG. 12, if desired an overtravel pressure relief valve 212 may be provided to limit the maximum pressure of the gas in the chamber 54.

In use, typically the gas spring assembly 20 is repeatedly cycled with each cycle including a retraction stroke of the piston rod 26 and collar 140 from a fully extended position as shown in FIG. 3 to a retracted position where the collar 140 is disengaged and spaced from the seal 162 such as shown in FIG. 4 and a return stroke to the fully extended position. During an initial part of the retraction stroke the check valves 178 open and hydraulic oil freely flows through the passages 176 from the main hydraulic chamber 106 into the expanding volume of the secondary hydraulic chamber 146 until the collar 140 disengages from the seal 162 and may continue to flow through these passages until the piston rod 26 and collar 140 reach the desired retracted position. Typically, after at least an initial part of the return stroke from this desired retracted position, the collar 140 engages the seal 162 to provide the secondary hydraulic chamber 146 and the check valves 178 close such as shown in FIG. 5 and as the collar 140 and the piston rod 26 further advance to their fully extended position hydraulic oil flows from the secondary hydraulic chamber 146 (as it decreases in volume) through the variable restricted orifice 192 to decrease the velocity or rate of return to their fully extended position. Since the effective cross sectional area of the variable restriction orifice 192 decreases as it passes through the seal 162, the velocity or rate at which the piston rod 26 and the collar 140 move to their fully extended position continues to decrease.

In use of the gas spring assembly 20, the force yieldably biasing the piston rod 26 to its extended position is believed to be substantially constant since it is a function of the pressure of the compressed gas in the accumulator gas chamber 54 although it may vary somewhat due to heating and thus expansion of the hydraulic oil and/or heating of the compressed gas which may occur due to rapid cycling of the piston rod. But when the piston rod 26 is retracted and the piston 42 in the accumulator travels up, the gas chamber decreases and thus the pressure of the gas will increase. The presently disclosed gas spring may eliminate the need for separate shock absorbers spaced laterally away from prior gas springs that do not have one or more of the inventive features disclosed herein.

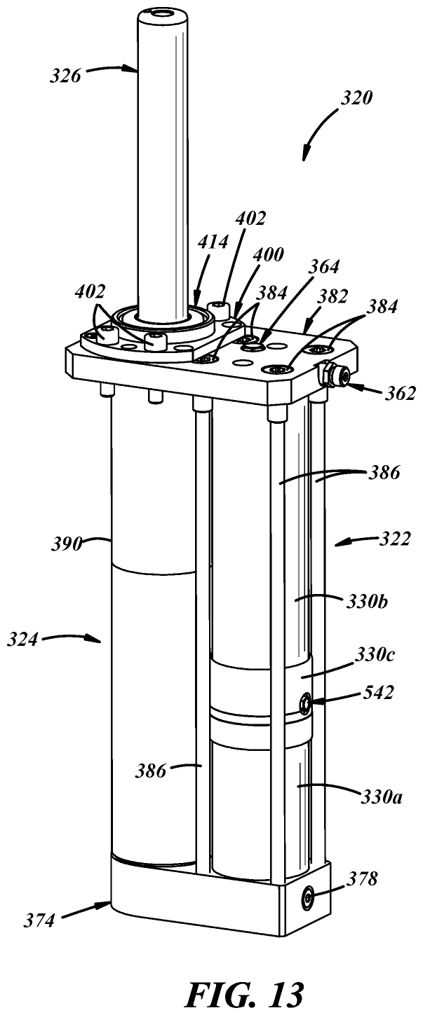

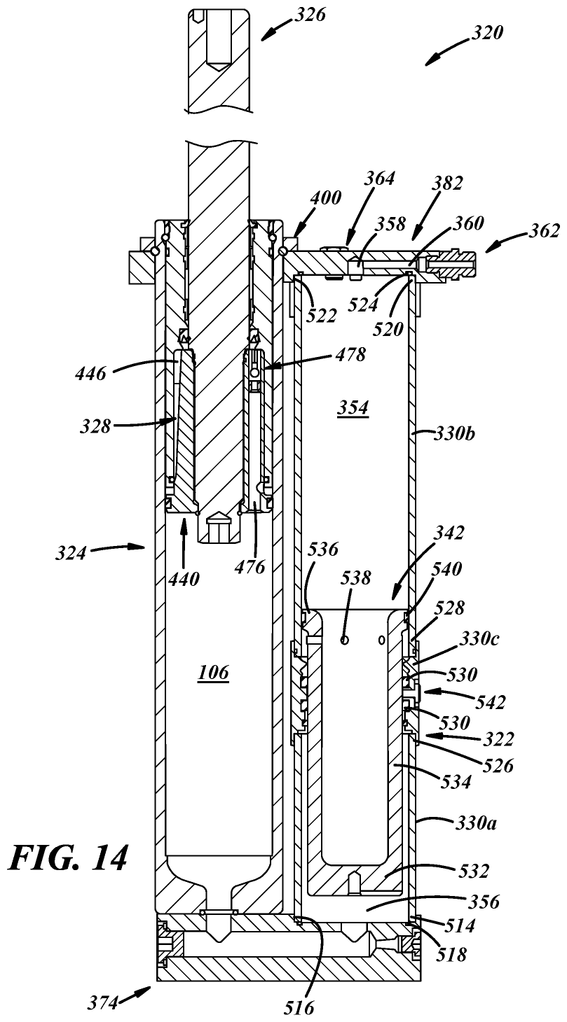

FIGS. 13 through 17 show another illustrative embodiment of a gas spring assembly 320. This embodiment is similar in many respects to the embodiment of FIGS. 1—12 and like numerals between the embodiments generally designate like or corresponding elements throughout the several views of the drawing figures. Accordingly, the descriptions of the embodiments are hereby incorporated into one another, and description of subject matter common to the embodiments generally may not be repeated.

With reference to FIG. 13, the gas spring assembly 320 includes an accumulator cylinder 322 including a casing 330a,b,c, and a hydraulic cylinder 324 in fluid communication with the accumulator cylinder 322 and including a casing 390 and a piston rod 326 partly slidably carried in the casing 390. The assembly 320 further includes a base plate 374 on which lower ends of the cylinders 322, 324 are supported and through which the cylinders 322, 324 fluidically communicate with one another. Although not shown, the hydraulic cylinder 324 may be coupled to the base plate 374 via fasteners, welding, threading, or any other suitable coupling. The assembly 320 additionally includes a top plate 382 coupled to upper ends of the cylinders 322, 324, and fastened to the base plate 374 via suitable fasteners, for instance, cap screws 384 and tie rods 386 that may have upper ends threaded to the cap screws 384 and lower ends threaded into the base plate 374. The assembly 320 also includes a retainer plate 400 fastened to the top plate 382 via cap screws 402 to retain the casing 390 to the top plate 382. Accordingly, the casings 330a,b,c, 390 of the accumulator and hydraulic cylinders 322, 324 are axially trapped between the base and top plates 374, 382.

The assembly 320 is structurally and functionally similar to the assembly 20 illustrated in FIGS. 1-12, with some differences that will be described in detail below, with reference to FIGS. 13-17.

According to a first difference, the assembly 320 includes a gas path for charging and/or discharging a gas chamber 354. The gas path includes a port 358 integrated into the top plate 382 and in communication with the gas chamber 354, and with a passage 360 also integrated into the top plate 382 and communicating with a fill adapter 362 for opening and closing communication with the passage 360.

According to a second difference, an overpressure relief valve assembly 364, a rupture disc, or the like may also be received in a through passage (not shown) through the top plate 382 to communicate the gas chamber 354 with the atmosphere exteriorly of the casing 330a,b,c in the event of, and to relieve, an overpressure condition occurring in the gas chamber 354.

According to a third difference, the accumulator assembly 322 has a multi-piece casing 330a,b,c including a first or lower casing 330a having a lower end 514 that may be carried in a counterbore 516 in an upper surface of the base plate 374 and sealed thereto via one or more seals 518. The lower casing 330a may be composed of metal, for instance, aluminum or steel tubing and, thus, may be opaque, and facilitates heat dissipation through the cylinder 322. The casing 330a, b,c also includes a second or upper casing 330b having an upper end 520 that may be carried in a counterbore 522 in a lower surface of the top plate 382 and sealed thereto via one or more seals 524. The upper casing 330b may be composed of a composite, for instance, POLYSIGHT brand composite tubing available from Polygon Composites (www.poblygoncomposites.com) and, thus, may be translucent. Accordingly, one can see various positions of the piston 342 when filling the gas spring assembly 320 with hydraulic fluid and/or when charging the gas spring assembly 320 with gas. The casing 330a,b,c further includes a third or intermediate casing 330c coupled to the lower and upper casings 330a.b. The intermediate casing 330c may include a throughbore that has one or more grooves, reliefs, or the like to carry one or more elements 530 like seals, wipers, bushings, bearings, and/or the like, and a lower counterbore that receives an upper end 526 of the lower casing 330a, and an upper counterbore that receives a lower end 528 of the upper casing 330b. More specifically, the intermediate casing 330c may be coupled between the lower and upper casings 330a,b and may carry axially spaced seals 530 to cooperate with the piston 342 to further define and separate the hydraulic fluid accumulation chamber 536 and the gas chamber 354.

According to a fourth difference, the piston 342 is much longer than the previously disclosed piston 42 of FIGS. 1-14, and has a base wall 532 at a closed end, a side wall 534 extending upwardly from the base wall 532, and an outwardly flared flange 536 terminating the side wall 534 at an open end. The piston 342 also may include one or more transversely extending holes 538 proximate the open end, and a guide ring 540) carried in a corresponding groove of the flange 536. The guide ring 540 contacts an interior surface of the translucent casing 330b and, thus, is easy to see externally of the casing 330b. In other embodiments, the piston 342 need not include the flange 536 or the guide ring 540 and, instead, the sidewall 534 could be straight with a slight annular gap between an outer surface of the sidewall 534 and an interior surface of the translucent casing 330b to allow visualization of the positions of the piston 342.

According to a fifth difference, the casing 330a,b,c also may include a gas vent 542 through a side thereof. More specifically, the intermediate casing 330c carries the gas vent 542 in a corresponding vent passage positioned axially between two seals 530. The gas vent 542 permits any gas from the gas chamber 354 that might be leaking past an upper one of the seals 530 to vent out the side of the casing 330c to atmosphere, instead of leaking into hydraulic fluid in the hydraulic fluid accumulator chamber 356, which leakage could cause the hydraulic fluid to lose its incompressibility characteristics.

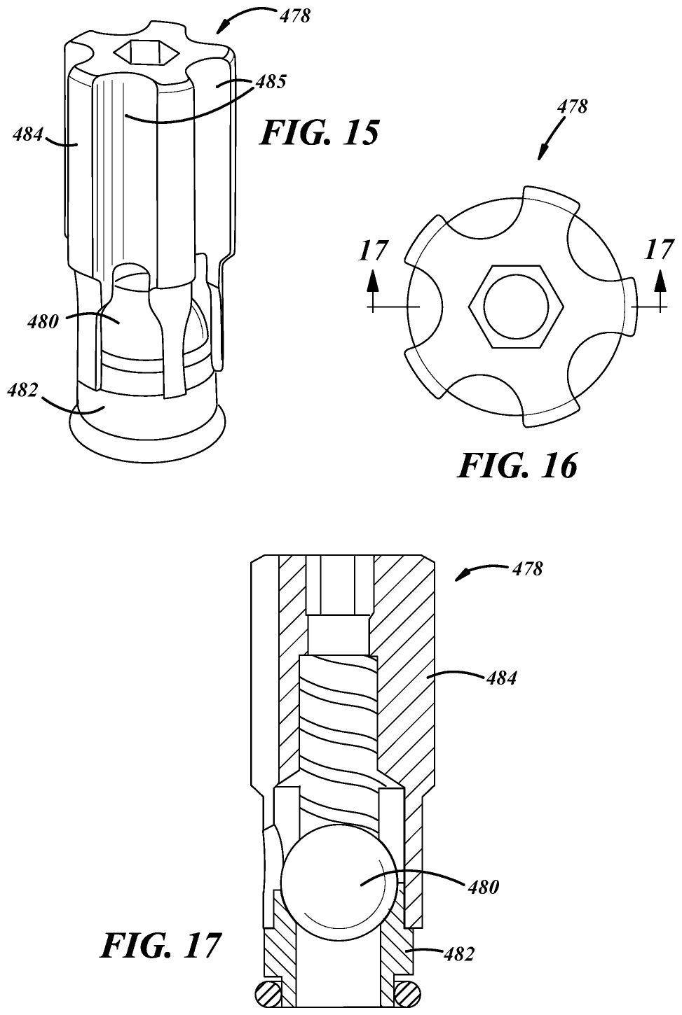

According to a sixth difference, the hydraulic cylinder 324 has a collar 440 with one or more passages 476 carrying one or more check valves 478. With reference to FIGS. 15-17, each check valve 478 includes a ball 480, a seat 482 against which the ball 480 sealingly seats, and a retainer 484 coupled to the seat 482 and against which the ball 480 may move within but not seal against, such that fluid can flow around the ball 480 and through external flutes 485.

While the forms and embodiments of the invention described herein constitute presently preferred forms and embodiments, many others are possible any may occur to one skilled in the art. It is not intended to mention herein all the possible equivalent forms and embodiments or ramifications of the invention. The terms used herein are merely descriptive, rather than limiting, and various changes may be made without departing from the spirit or scope of the invention.

1. An industrial gas spring (20, 20′, 320) with a hydraulic damper (28) comprising:
a first cylinder (24, 324) having an inner cylindrical surface (104) defining at least in part a first hydraulic chamber (106) constructed to receive an essentially incompressible hydraulic fluid therein:
a piston rod (26, 326) having a first end received in the first hydraulic chamber, a second end axially outboard of the first hydraulic chamber, and the piston rod being movable between extended and retracted positions relative to the first cylinder;
a collar (140, 440) received in the first hydraulic chamber, having first and second axially spaced apart ends and carried by the piston rod for movement therewith:
a seal (162) carried by the first cylinder and engaging the collar during a portion of movement of the piston rod to its extended position and only a portion of movement of the piston rod from its extended position toward its retracted position with the collar and the seal defining at least in part a second hydraulic chamber (146, 446) during such movements of the piston rod:
at least one passageway (176, 476) in the collar communicating with the first and second ends of the collar:
a separate check valve (178, 478) in each passageway of the at least one passageway and configured to close to at least essentially prevent flow of hydraulic fluid through its associated passageway from the second hydraulic chamber during at least part of such portion of movement of the piston rod to its extended position and also configured to open to permit flow of hydraulic fluid into the second hydraulic chamber during at least part of such movement of the piston rod from its extended position toward its retracted position:
a restricted orifice (192) carried by the collar and through which hydraulic fluid flows from the second hydraulic chamber during at least part of such movement of the piston rod to its extended position to decrease the velocity of at least part of such movement of the piston rod to its extended position:
a second cylinder (22, 322) having an inner cylindrical surface (44);
a piston (42, 342) having first and second sides, slidably received in the second cylinder, on the first side defining at least in part with the inner cylindrical surface of the second cylinder a hydraulic fluid accumulation chamber (56, 356) which communicates with the first hydraulic chamber of the first cylinder, and on the second side defining at least in part with the inner cylindrical surface of the second cylinder a gas chamber (54, 354); and
a seal (50) carried by the piston and providing a seal between the gas chamber and the hydraulic fluid accumulation chamber.

2. The industrial gas spring of claim 1 which also comprises a housing (114, 414) carried by the first cylinder and having a bore (142) through which the piston rod is slidably received, and a counterbore (144) opening toward the first hydraulic chamber and constructed to slidably receive at least part of the collar therein to provide at least in part with the collar the second hydraulic chamber as the piston rod moves to its extended position.

3. The industrial gas spring of claim 2 in which the seal engageable with the collar is received in a groove (164) in the housing adjacent the opening of the counterbore toward the first hydraulic chamber.

4. The industrial gas spring of claim 2 wherein the collar has a cylindrical surface radially inward of and spaced from the inner cylindrical surface of the first cylinder and the restrictive orifice opens to this cylindrical surface of the collar and in cross section has an area which varies and decreases as it extends longitudinally toward the first hydraulic chamber.

5. The industrial gas spring of claim 1 wherein the collar has an outer cylindrical surface adjacent the inner cylindrical surface of the first cylinder and the restrictive orifice opens to this cylindrical surface of the collar and in cross section has an area which varies and decreases as it extends longitudinally toward the first hydraulic chamber.

6. The industrial gas spring of claim 1 wherein the at least one passageway in the collar comprises a plurality of circumferentially spaced apart passageways each communicating with the first and second ends of the collar.

7. The industrial gas spring of claim 1 which also comprises an overpressure relief valve or rupture disc (64) communicating with the gas chamber of the gas chamber of the second cylinder.

8. The industrial gas spring of claim 1 which also comprises a visually observable indicator (194) of the position of the piston in the second cylinder.

9. The industrial gas spring of claim 1 which also comprises a sight glass (198) with an axially elongate bore and carried by the second cylinder, and a rod carried by the piston for movement therewith, extending through the gas chamber and slidably received in the axial elongate bore of the sight glass to provide an indication of the position of the piston in the second cylinder.

10. The industrial gas spring of claim 9 which also comprises a seal (200) between the rod and the gas chamber and carried by the second cylinder.

11. The industrial gas spring of claim 1 which also comprises an electrical or electronic sensor carried by the second cylinder and configured to provide an indication of the axial position of the piston in the second cylinder.

12. The industrial gas spring of claim 1 wherein the hydraulic chamber includes an end wall, the piston is axially movable relative to the end wall, and also comprises a proximity sensor (202) carried by the second cylinder adjacent the end wall and a rod (204) carried by the piston for movement therewith and the proximity sensor is responsive to movement of the rod to provide an electric or electronic signal indicating the axial position of the piston relative to the end wall of the hydraulic chamber.

13. The industrial gas spring of claim 12 wherein the gas chamber includes an end wall, the piston is axially movable relative to the end wall of the gas chamber, and also comprises a sensor carried by the end wall of the gas chamber and configured to provide an electric or electronic signal indicating the axial position of the piston relative to the end wall of the gas chamber.

14. The industrial gas spring of claim 1 wherein the gas chamber includes an end wall, the piston is axially movable relative to the end wall of the gas chamber, and also comprises a sensor carried by the end wall of the gas chamber and configured to provide an electric or electronic signal indicating the axial position of the piston relative to the end wall of the gas chamber.

15. The industrial gas spring of claim 14 wherein the sensor carried by the end wall of the gas chamber comprises a linear position sensor.

16. A system, comprising:
the industrial gas spring of claim 1; and
a machine element operatively coupled to the industrial gas spring, wherein the system does not include a shock absorber separate from the industrial gas spring and spaced apart therefrom in operative connection to the machine element.

17. An industrial gas spring (20, 20′, 320), comprising:
a hydraulic cylinder (24, 324) having an inner cylindrical surface defining at least in part a first hydraulic chamber constructed to receive hydraulic fluid therein:
a piston rod (26, 326) having a first end received in the first hydraulic chamber, a second end axially outboard of the first hydraulic chamber, and the piston rod being movable between extended and retracted positions relative to the hydraulic cylinder:
a collar (140, 440) received in the first hydraulic chamber, having first and second axially spaced apart ends and carried by the piston rod for movement therewith:
a seal (162) engaging the collar during a portion of movement of the piston rod to its extended position and only a portion of movement of the piston rod from its extended position toward its retracted position with the collar and the seal defining at least in part a second hydraulic chamber during such movements of the piston rod:
an accumulator cylinder (22, 322) having an inner cylindrical surface; and
a piston (42, 342) having first and second sides, slidably received in the accumulator cylinder, on the first side defining at least in part with the inner cylindrical surface of the accumulator cylinder, a hydraulic fluid accumulation chamber (56, 356) which communicates with the first hydraulic chamber of the hydraulic cylinder, and on the second side defining at least in part with the inner cylindrical surface of the accumulator cylinder a gas chamber (54, 354).

18. The industrial gas spring of claim 17, further comprising:
a passageway (176, 476) in the collar communicating with the first and second ends of the collar:
a check valve (178, 478) in the passageway and configured to close to at least prevent flow of hydraulic fluid through the passageway from the second hydraulic chamber during at least part of such portion of movement of the piston rod to its extended position and also configured to open to permit flow of hydraulic fluid into the second hydraulic chamber during at least part of such movement of the piston rod from its extended position toward its retracted position; and
a restricted orifice (192) carried by the collar and through which hydraulic fluid flows from the second hydraulic chamber during at least part of such movement of the piston rod to its extended position to decrease the velocity of at least part of such movement of the piston rod to its extended position.

19. The industrial gas spring of claim 17, further comprising:
a seal (50) carried by the piston and providing a seal between the gas chamber and the hydraulic fluid accumulation chamber.

20. An industrial gas spring (320), comprising:
a base plate (374) having a hydraulic fluid passage:
a top plate (382) positioned above the base plate:
a hydraulic cylinder (324) coupled between the base and top plates and having a first inner cylindrical surface defining at least in part a first hydraulic chamber constructed to receive hydraulic fluid therein and in fluid communication with the hydraulic fluid passage of the base plate:
a piston rod (326) having a first end received in the first hydraulic chamber, a second end axially outboard of the first hydraulic chamber, and the piston rod being movable between extended and retracted positions relative to the hydraulic cylinder:
an accumulator cylinder (322) coupled between the base and top plates and having a second inner cylindrical surface:
a piston (342) having first and second sides, slidably received in the accumulator cylinder, on the first side defining at least in part with the inner cylindrical surface of the accumulator cylinder, a hydraulic fluid accumulation chamber which communicates with the first hydraulic chamber of the hydraulic cylinder, and on the second side defining at least in part with the inner cylindrical surface of the accumulator cylinder a gas chamber; and
a casing (330) establishing the inner cylindrical surface of the accumulator, being in fluid communication with the hydraulic fluid passage of the base plate, and including a lower casing (330a) composed of metal and coupled to the base plate, an upper casing (330b) composed of a translucent material and coupled to the upper plate, and an intermediate casing (330c) coupled between the lower and upper casings and carrying axially spaced seals (530) to cooperate with the piston to further define the hydraulic fluid accumulation chamber and the gas chamber.

21. The industrial gas spring of claim 20 wherein the intermediate casing includes a gas vent (542) to externally vent any gas leaking past one or more of the axially spaced seals to prevent gas in the gas chamber from migrating into hydraulic fluid in the hydraulic fluid accumulation chamber.
